(19) United States
(12) Patent Application Publication
(10) Pub. No.: US 2024/0048091 A1
(43) Pub. Date: Feb. 8, 2024

(54) Solar Tracker

(71) Applicant: Jonathan Carl Ricker, Shrewsbury, MA (US)

(72) Inventor: Jonathan Carl Ricker, Shrewsbury, MA (US)

(21) Appl. No.: 18/365,768

(22) Filed: Aug. 4, 2023

Related U.S. Application Data
(60) Provisional application No. 63/474,291, filed on Aug. 4, 2022.
(60) Provisional application No. 63/373,580, filed on Aug. 26, 2022.

(51) Int. Cl. H02S 20/32; F24S 30/452; F24S 23/77; F24S 50/20; F24S 50/40; H02S 40/22

(52) U.S. Cl. CPC H02S 20/32; F24S 30/452; F24S 23/77; F24S 50/20; F24S 50/40; H02S 40/22; F24S 2030/133

(57) ABSTRACT

A solar tracking system comprising a platform, a system housing, at least one solar panel, at least one motor, and a cable. The at least one solar panel is attached to the platform and configured to generate electricity from photons. The platform further comprises a sensor device configured to gather information relating to light and temperature. The at least one motor connects to the platform by the cable and is configured to rotate the platform. The at least one motor may also be connected to an actuator on the at least one solar panel and may be configured to adjust the tilt of the at least one solar panel. The system housing comprises a processor communicatively connected to the sensor device and the at least one motor. The processor is configured to activate the at least one motor based on information gathered by the sensor device.

### FIELD OF THE INVENTION

The present invention relates generally to the field of solar energy. More specifically, the present invention is a device that utilizes tracking systems to increase solar power output.

### BACKGROUND OF THE INVENTION

Several devices and systems have been created in an attempt to direct solar panels towards the sun to increase its effects against a turbine blade or impact impeller. However, many of these systems cost a large amount to run properly and are not durable with the use of large solar arrays. Large solar arrays utilized in the past with trackers have structural stress and fatigue problems within the system, causing the solar arrays to tilt towards the optimal solar production direction. Other innovations include wheels with an extra axle moving the wheel along the perimeter of the wheel connected to the transmission.

An objective of the present invention is to provide users with a solar panel tracking system, that is simple, robust, and low-cost. The present invention intends to provide users with a device that automatically repositions solar panels throughout the day to follow the sun's position from east to west with a dual tracking capability. In order to accomplish that, a preferred embodiment of the present invention comprises a platform and system housing. The system housing allows for the plurality of solar panels to be rotated to obtain the optimal amount of solar energy. Thus, the present invention is a solar tracker that automatically repositions a plurality of solar panels throughout the day to receive more direct sunlight.

### SUMMARY OF THE INVENTION

The present invention is a solar tracking system configured to help with obtaining direct sunlight without overheating the of solar panels. The present invention seeks to produce the maximum amount of power utilizing low cost means of a robust structure and solar tracker to increase the output of solar energy. The present invention also provides a more durable tracker by resolving structural stress problems in traditional solar tracker. The present invention reduces the manufacturing cost by using more but smaller components. The present invention reduces the cost of solar energy in order to implement a finance plan including an innovative plan to bring a high rate of return and lowering the cost. Another object of embodiments of the invention is to allow stiffer and more rigid solar tracker by making the moving solar panels smaller. Another object of the invention is an improvement and cost reduction of using reflectors to increase power output without adding heat to the solar panels. A further object of embodiments of the invention is to provide an easier construction method. Yet another object of embodiments of the invention is to allow for construction with standard parts which do not need to be custom which can allow for retrofitting existing solar projects. Still yet another object of embodiments of the invention is to enhance structural support. Another object of the invention is to provide weather protection and additional structural support with its roof. In order to accomplish this the present invention comprises a platform that monitors the sun positioning and properly captures direct sunlight. Further, the system housing rotates the platform with a motor to obtain the optimal amount of solar energy. Thus, the present invention is a solar tracker that automatically repositions a plurality of solar panels throughout the day to receive more direct sunlight.

### BRIEF DESCRIPTION OF THE DRAWINGS

FIG. 1 is a top rear perspective view of the present invention in accordance with at least one embodiment.

FIG. 2 is a bottom front perspective view of the present invention in accordance with at least one embodiment.

FIG. 3 is a front view of the present invention in accordance with at least one embodiment.

FIG. 4 is a rear view of the present invention in accordance with at least one embodiment.

FIG. 5 is a left-side view of the present invention in accordance with at least one embodiment.

FIG. 6 is a right-side view of the present invention in accordance with at least one embodiment.

FIG. 7 is a top view of the present invention in accordance with at least one embodiment.

FIG. 8 is a bottom view of the present invention in accordance with at least one embodiment.

FIG. 9 is a block diagram of components of the present invention in accordance with at least one embodiment.

### DETAIL DESCRIPTIONS OF THE INVENTION

All illustrations of the drawings are for the purpose of describing selected versions of the present invention and are not intended to limit the scope of the present invention.

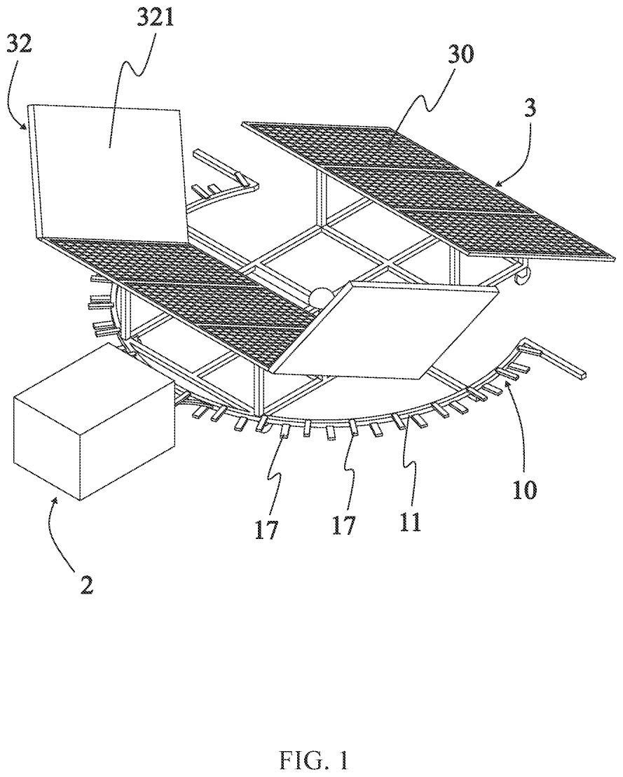

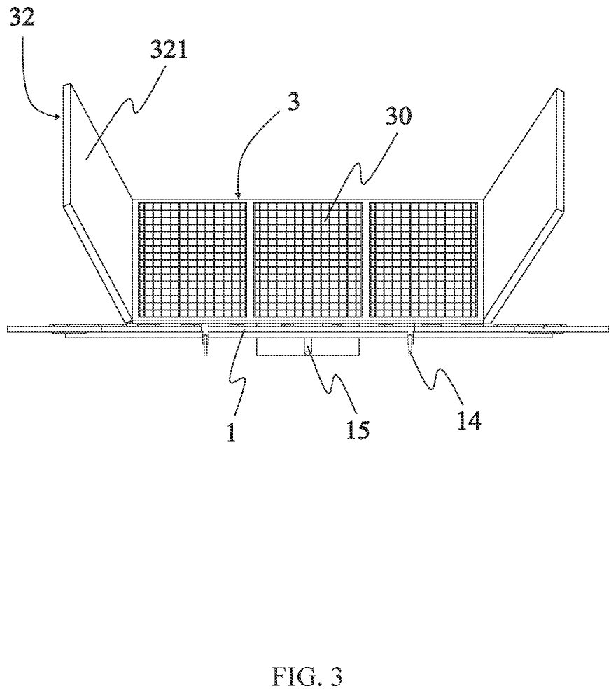

As shown in FIG. 1-8, the present invention is a solar tracker that automatically tracks the position of the sun. An objective of the present invention is to provide users with a solar tracker that provides at least one solar panel 3 with regular direct sunlight. The present invention intends to provide users with a device that can increase power output while still being a cost-efficient option. To accomplish this the present invention comprises a platform 1 and a system housing 2, along with the at least one solar panel 3. Many of these components allow for the user to obtain the maximum amount of solar energy while preventing the plurality of solar panels from overheating. In the preferred embodiment, the platform 1 is connected with the system housing 2 through a cable 4. Thus, the present invention is a solar tracker that automatically repositions a plurality of solar panels throughout the day to receive more direct sunlight.

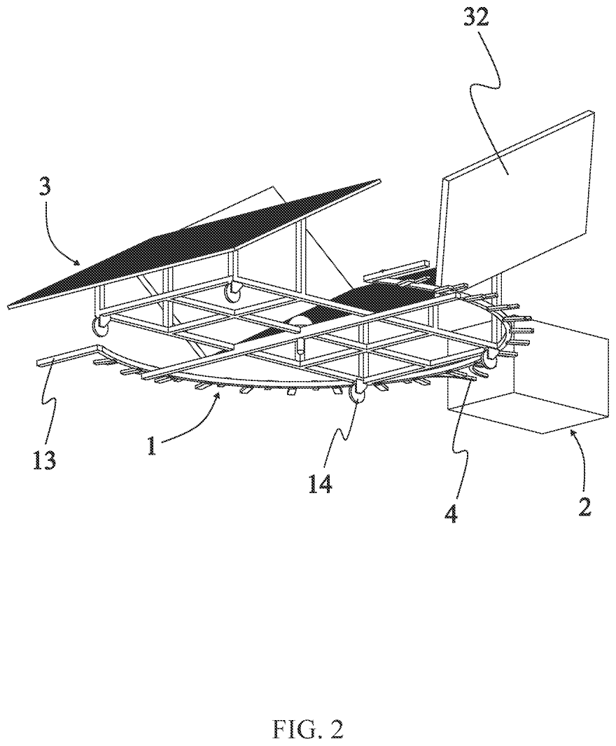

The present invention receives solar energy through the platform 1 shown in FIG. 2. The platform 1 comprises a rounded structure 10 and is preferably made with a metal material designed to support several components positioned on top of it. In its preferred embodiment the platform 1 comprises the rounded structure 10, a structure edge 11, at least one sensor device 12, a plurality of reflectors, a plurality of dampers 13, a plurality of wheels 14, a central bearing 15, a panel support 16, and a plurality of cable guides 17. The at least one solar panel 3 is attached to the platform 1 as shown in FIG. 1, preferably centrally positioned on the platform 1. The at least one solar panel 3 is a device that is capable of taking solar rays and turning it into electrical energy or generating electricity from photons. The at least one solar panel 3 is positioned at an angle that can be further adjusted to ensure optimal direct sunlight hits the at least one solar panel 3 throughout the day. The at least one solar panel 3 further comprises a window film 30, an actuator 31, and at least one reflector 32. The window film 30 is positioned at the top of each of the at least one solar panel 3 in a horizontal position. The window film 30 is configured to block or filter infrared light. By blocking infrared rays that do not add to the power output of the at least one solar panel 3, visible light can still reach the at least one solar panel 3 without added head from infrared rays. The window film 30 allows high visible light transmission and reduces the surface heat of the plurality of solar panels as infrared rays contribute to approximately half of the surface heat of objects in direct sunlight. The at least one reflector 32 is positioned on the plurality of solar panels or on the platform 1 and is preferably oriented to direct light toward the at least one solar panel 3. The at least one reflector 32 comprises a reflective component 321. In the preferred embodiment, the at least one reflector 32 is a flat panel wrapped in material such as shrink wrap and mylar. The at least one reflector 32 may be configured to heat a heat engine in an alternative embodiment of the present invention. The at least one reflector 32 concentrates direct solar rays to temperatures above 250 degrees for small focus areas by using a reflective component 321 of shrink wrap and mylar or other similar materials. The actuator 31 is positioned on the at least one solar panel 3, opposite the window film 30 and is configured to aid in attachment and adjustment of the at least one solar panel 3. The actuator 31 may be connected to the panel support 16 of the platform 1, facilitating an adjustable tilting connection between the platform 1 and the at least one solar panel 3 by way of the actuator 31 and the panel support 16. This design allows the at least one solar panel 3 to tilt upwards and downwards, adjusting the angle of the at least one solar panel 3 relative to the platform 1, properly optimizing the direct sunlight at various times throughout the day. The actuator 31 is designed to be very stable to hold up against potentially harsh weather and further comprises a potential north-south actuator 31 and east-west actuator 31.

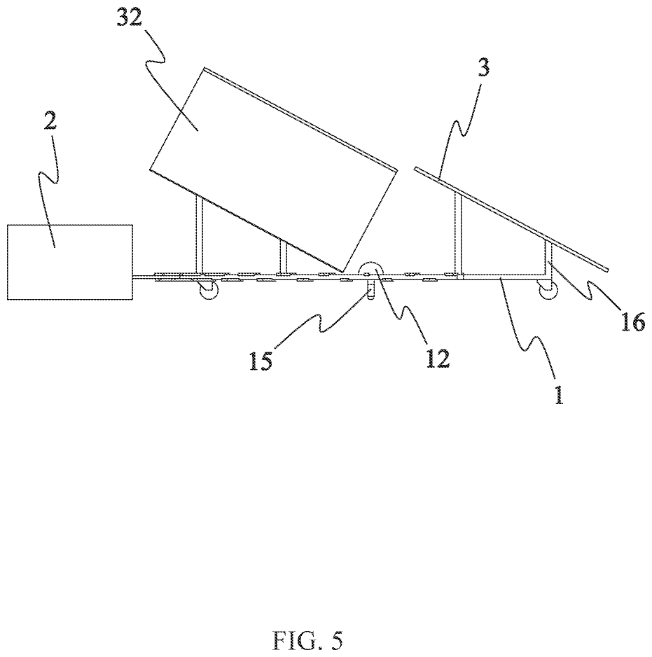

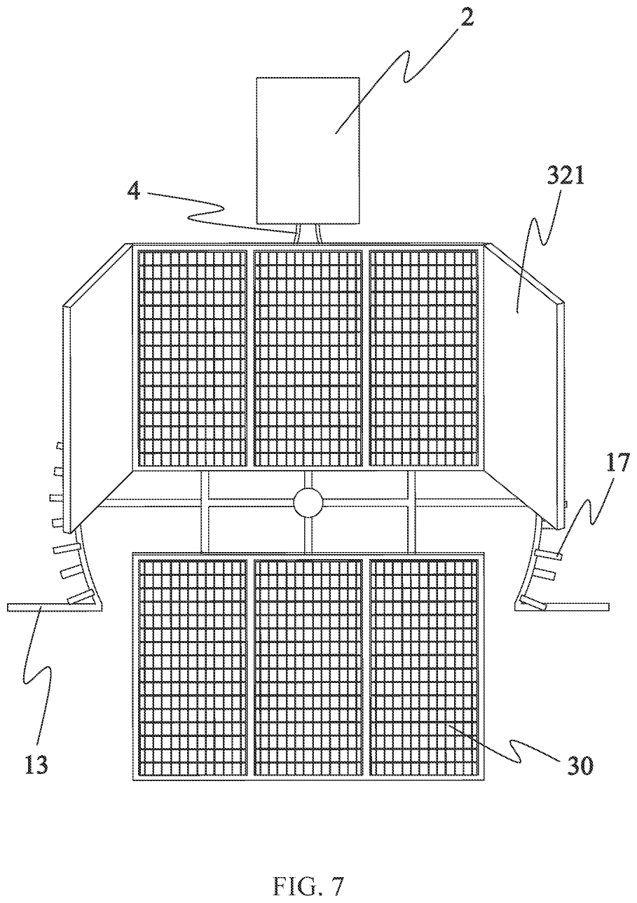

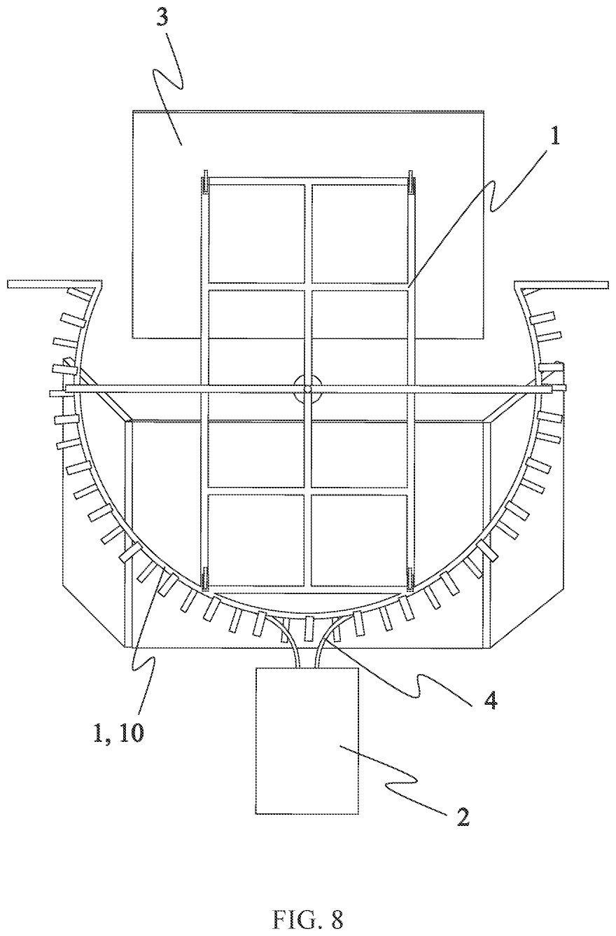

In reference to FIG. 7, the cable 4 is a lengthy flexible metal material that traverses most of the platform 1 circumference or structure edge 11 and mechanically connects the platform 1 with the system housing 2. The cable 4 may further comprises a plurality of fasteners that connect along the circumference of the platform 1. This design allows the cable 4 to directly rotate the platform 1 in either direction as the cable 4 moves seen in FIG. 5. To ensure the cable 4 stays positioned along the platform 1 circumference, a plurality of cable guides 17 is positioned along the platform 1 edge along the top and bottom. The cable 4 is arranged among the plurality of cable guides 17, preferrable with individual guides of the plurality of cable guides 17 positioned on either side of the cable 4, ensuring that the cable 4 does not slip off the platform 1. The platform 1 smoothly rotates due to the plurality of wheels 14 and the central bearing 15. The plurality of wheels 14 is oppositely positioned on the platform 1 from the at least one solar panel 3, preferably located at the corners of the bottom of the platform 1 to allow for lateral movement as well as rotation. Furthermore, the central bearing 15 is located at the rotational center of platform 1 and is configured to act as a rotational axis for the platform 1. The central bearing 15 is restricted to rotational movement and allows the platform 1 to rotate clockwise or counterclockwise around the central bearing 15 as the cable 4 moves one direction or another. The plurality of wheels 14 is positioned at a distance far enough from the central bearing 15 to reduce the cost of the length of additional supporting rails for the platform 1 while still providing the required stability shown in FIG. 8. Positioned along the edge of the platform 1 adjacent to the plurality of fasteners is the plurality of dampers 13. The plurality of dampers 13 is a bumper made of a soft material that allows prevents the cable 4 from going too far along the platform 1. The plurality of dampers 13 extends from the platform 1 and is configured to prevent rotation of the platform 1 beyond a predetermined rotation. The plurality of dampers 13 provides added protection to ensure a slowing of movement during potential events such as high wind events or malfunctioning parts.

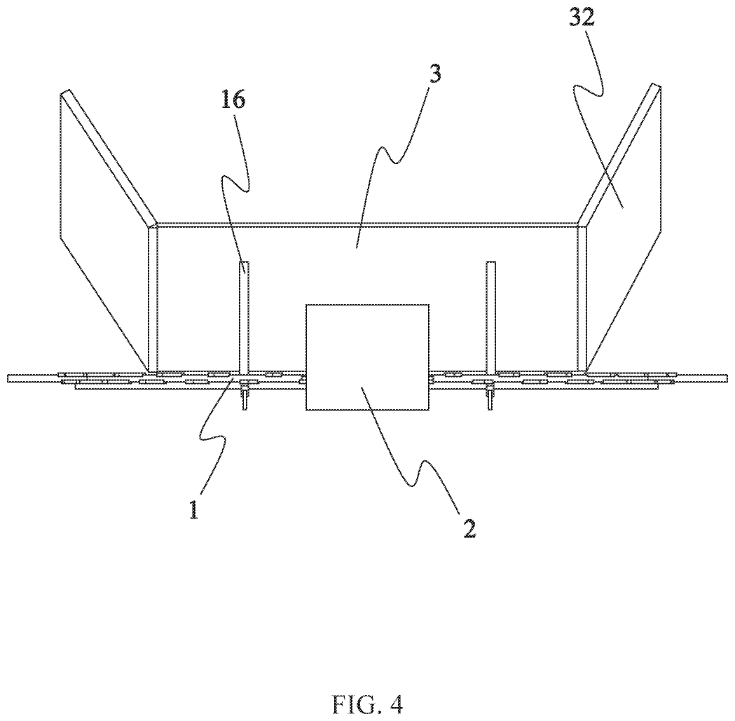

The sensor device 12 is positioned on the platform 1, preferably at the center, shown in FIG. 4, where it can be exposed to sunlight. The sensor device 12 monitors the amount of direct sunlight being received. The sensor device 12 is configured to gather initial information relating to optimal solar energy. The sensor device 12 may further comprise a light sensor 121 and a temperature sensor 122 or heat sensor. The light sensor 121 is configured to gather information about the direction and intensity of light while the temperature sensor 122 is configured to gather information about the temperature at the sensor device 12. The sensor device 12 therefore gathers information vital to determining the best positioning of the at least one solar panel 3 for optimal power generation as well as tracking the temperatures of the system in order to prevent overheating.

In addition, a plurality of trackers may be vertically mounted on the platform 1. The plurality of trackers is rotated with the platform 1 and is designed to seek the optimal location for the plurality of solar panels by measuring the best power output. The plurality of trackers further comprises a plurality of reflectors and a double-sided solar panel. In an alternative embodiment plurality of trackers could utilize the at least one reflector 32 for concentrated solar with heat engines to produce electricity. Furthermore, furling methods may be used to control overheating to move the plurality of trackers away from the sun at a specified temperature and move back into position after cooling to a specified temperature. Further, the plurality of trackers and the at least one reflector 32 may be utilized for a stationary solar hot water structure. The at least one reflector 32 is designed with a mylar material with a silver or white colored shrink wrap. The at least one reflector 32 is designed to increase the power output while not significantly increasing the surface heat. It should be further noted that, the platform 1 can be created in many various shapes and sizes while still staying within the scope of the present invention.

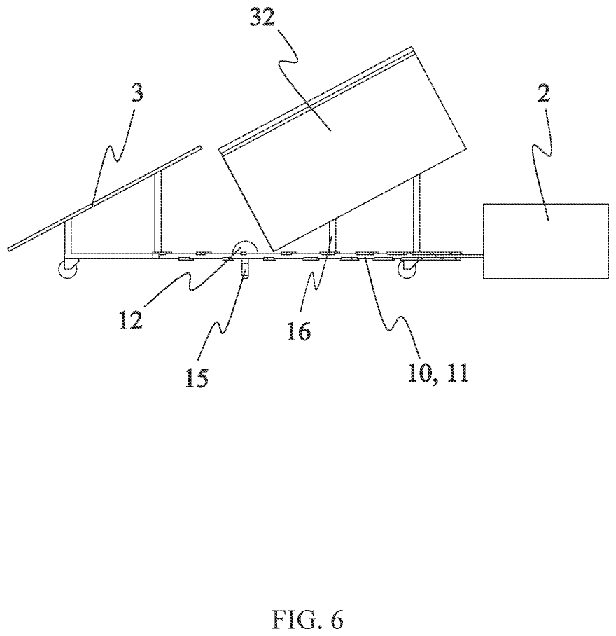

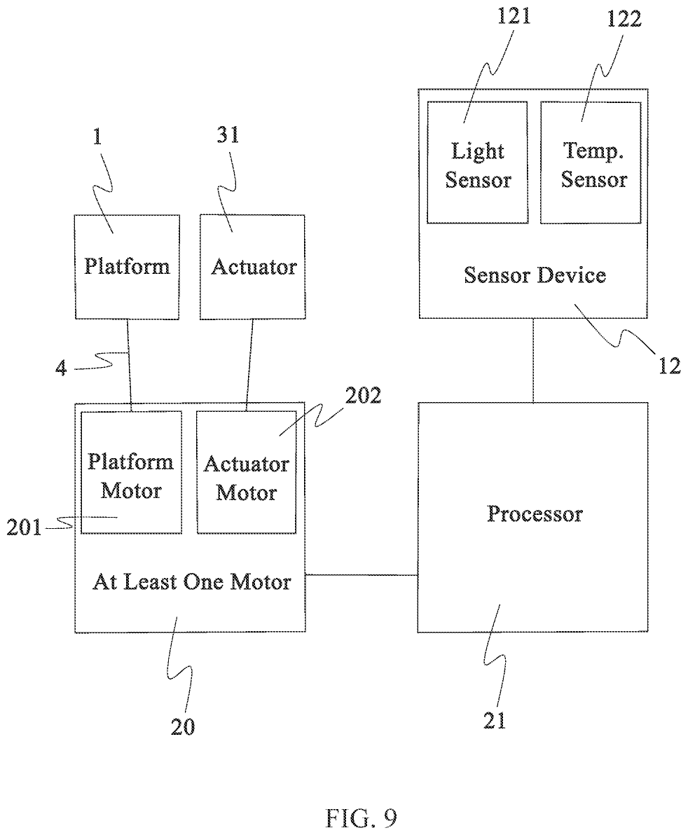

The system housing 2 connects with the platform 1 via the cable 4 seen in FIG. 6. The system housing 2 is preferably designed as a hollow rectangular box with a small opening for the cable 4 to pass through. In its preferred embodiment the system housing 2 comprises at least one motor 20 and a processor 21. In some embodiments, the at least one motor 20 may be outside of the system housing 2. The at least one motor 20 is preferably a mechanical device that can create an output torque that connects with the cable 4 moving it either direction. The at least one motor 20 is designed to operate at a low revolutions per minute to allow for precise adjustments in the direction the cable 4 moves and as a result the platform 1. The at least one motor 20 operates to turn the platform 1 to ensure the plurality of solar panels are receiving direct sunlight and obtaining the optimal amount of solar energy. The at least one motor 20 is may be configured to rotate the platform 1 as described above through connection to the platform 1 by the cable 4 and the at least one motor 20 may also be configured to adjust the angle of the at least one solar panel 3 relative to the platform 1 by way of the actuator 31. In one embodiment, the at least one motor 20 may comprise a platform motor 201 and an actuator motor 202, wherein the platform motor 201 is configured to rotate the platform and the actuator motor 202 is configured to adjust the angle of the at least one solar panel 3 relative to the platform 1. Referring to FIG. 9, the processor 21 is communicatively and electronically connected to the sensor device 12 and the at least one motor 20. The processor 21 is configured to receive information from the sensor device 12 and is also configured to activate the at least one motor 20 based on information gathered by the sensor device 12. The processor 21 may gather information from the sensor device 12 as well as any auxiliary sensors on the solar tracking system and determine an optimal position for the at least one solar panel 3. The processor 21 preferably sends a signal to the at least one motor 20 to rotate the platform 1 slightly once every 20 to 30 minutes to reposition the platform 1 in the optimal position for obtaining solar energy. In alternative embodiments, the period of time between adjustments of the platform 1 may be shorter or longer. The processor 21 is configured to not only control adjustment of the platform 1 and the at least one solar panel 3 for optimal power generation, but may also control the platform 1 and actuators 31 during hazardous conditions to ensure the at least one solar panel 3 is not damaged due to high winds, snowfall, or excessive heat.

In an alternative embodiment of the present invention, a protective wall may be placed surrounding the system to avoid wind damage. A clear greenhouse like structure may surround the solar tracking system for avoiding the outside weather and at the same time allow for sunlight to be exposed to the solar cells. The use of a vertical facing double side exposed solar cell could be viable in a greenhouse like environment. Solar cells on a lightweight platform 1 without the glass in the solar module on a tracker inside a greenhouse is an option to reduce the cost. Nitinol (or other shape memory alloys) as well as means to mimic natural sunflowers could be used to move the trackers to face the sun during the day. In an alternative embodiment CPACE (Commercial property Assessed Clean Energy) could be used by the public company and/or tax equity investors. Additional innovations include spinoff of shares into a private investment corporation with the goal of being a public entity for the specific purpose of allowing maximum benefit from the technology. At the same time, less stock issuances would be needed to produce and market. The spinoff will be non-dilutive to (company) user of innovation would receive equity from the investment group in exchange for a limited territory licensing agreement of technology for the use of projects with technology applications. It allows potentially earning lucrative licensing fees. The use of a partnership flip using a public company allows the developer to receive capital gains from the project realized in the present value of future profits instead of waiting for several years to receive profits if the developer was a private company receiving the bulk of the benefits after the partnership flip several years into the future. Other innovations include buying puts and/or writing calls simultaneously in order to hedge against long term electric price fluctuation risk. Upfront capital cost could be reduced or eliminated with our finance innovations using the research and development tax credit and using the reflective roof in conjunction with the accelerated tax depreciation or 30% investment tax credit. The program could be used for the investment of the additional trackers and other methods to increase power output as an additional feature for existing solar projects. Crowdfunding could be used to finance projects. The retrofits could be used to maximize solar renewable energy credits like SRECs in Massachusetts and other states.

An additional embodiment may comprise adding a low-cost solar carport with bamboo poles with plastic or light steel enclosures. Carport housing electric vehicle innovation comprise anti-collision software in and lightweight bamboo frame and/or light steel/plastic enclosure for the need of less batteries. Further carport pole or any tower support cost reductions may comprise helium balloons with bamboo poles or lattice towers with or without material comprising plastic or steel enclosures. Further innovations comprise an extra axle on the outer edge of the platform 1 as the axle that is connected to the transmission for increased leverage. Additional notes include the invention avoiding snow loads as an advantage. The at least one solar panel 3 may be optimized like the second actuator 31 of a dual axis tracker with an actuator 31 connected to the at least one solar panel 3 and the platform 1 adjusting the panel angle providing additional power output. A floating Stirling engine on water could provide an optimal cooling for a more efficient Stirling engine. The improved film in the heat reduction film technique may be used to increase power output 30 to 70 percent on existing solar projects without the innovations or solar trackers for a small additional cost. The thin and large area evaporation and/or rapid heating technique can be used to evaporate brine or heavy (or any) salt water. Brine can be stored in existing oil tanks reinforced with additional material on the outer skin to support the higher pressure. The material may comprise metal, wood or bamboo.

An additional embodiment is the use of the solar tracker as a potential very low-cost method of desalination of salt water. A forty-foot container could be placed on a very large concentrator enhanced platform 1. Salt water could be poured into the container and the concentrated heat would create steam to travel through a piping method or pipe to another forty-foot container at a stationary location near the solar platform 1 in which the condensation would create purified fresh water.

A similar approach can be used to purify wastewater. However, there would be an additional cost of maintaining certain temperatures while purifying wastewater. The solar tracker would comprise of using temperature sensors 122 to move the platform 1 slightly to reduce the very high temperature concentration to avoid evaporating waste elements. The purpose is to purify the water by evaporating the water that is not pure where the second container would have only pure water after the evaporation and condensation effort.

With all the components working in tandem with each other it can be seen that the present invention is a solar tracker that automatically repositions a plurality of solar panels throughout the day to receive direct sunlight for optimal power generation.

Although the invention has been explained in relation to its preferred embodiment, it is to be understood that many other possible modifications and variations can be made without departing from the spirit and scope of the invention.

What is claimed is:

1. A solar tracking system, comprising:
a platform;
a system housing;
at least one solar panel;
a sensor device;
at least one motor;
the at least one solar panel being attached to the platform;
the at least one solar panel configured to generate electricity from photons;
the sensor device being attached to the platform;
the system housing comprising a processor;
the at least one motor being configured to rotate the platform;
the at least one motor being configured to adjust the angle of the at least one solar panel relative to the platform;
the processor communicatively connected to the sensor device and the at least one motor; and
the processor being configured to activate the at least one motor based on information gathered by the sensor device.

2. The solar tracking system of claim 1, further comprising:
at least one reflector;
a cable;
the platform further comprising a rounded structure and a structure edge;
the at least one motor connected to the structure edge by the cable;
the at least one reflector having a reflective component; and
the at least one reflector being oriented to direct light toward the at least one solar panel.

3. The solar tracking system of claim 1, further comprising:
the platform further comprising at least one panel support;
the at least one solar panel comprising a window film and an actuator;
the window film being configured to filter infrared light;
the at least one solar panel being attached to the platform by connection between the panel support and the actuator; and
the at least one motor being configured to adjust the angle of the at least one solar panel relative to the platform by way of the actuator.

4. The solar tracking system of claim 1, further comprising:
the at least one motor comprising a platform motor and an actuator motor;
the platform motor being configured to rotate the platform; and
the actuator motor being configured to adjust the angle of the at least one solar panel relative to the platform.

5. The solar tracking system of claim 1, further comprising:
the platform comprising a plurality of wheels and a plurality of dampers;
the plurality of wheels oppositely positioned on the platform from the at least one solar panel;
the plurality of dampers extending from the platform; and
the plurality of dampers configured to prevent rotation of the platform beyond a predetermined rotation.

6. The solar tracking system of claim 2, further comprising:
the platform further comprising a central bearing and a plurality of cable guides;
the central bearing centrally located on the platform;
the platform being configured to rotate around the central bearing;
the plurality of cable guides positioned along the structure edge; and
the cable being arranged among the plurality of cable guides.

7. The solar tracking system of claim 1, further comprising:
the sensor device further comprising a light sensor and a temperature sensor;
the light sensor configured to gather information about the direction and intensity of light; and
the temperature sensor configured to gather information about the temperature at the sensor device.

8. A solar tracking system, comprising:
a platform;
a system housing;
at least one motor;
at least one solar panel;
at least one reflector;
a cable;
the platform comprising a rounded structure and a structure edge;
the at least one motor connected to the structure edge by the cable;
the at least one motor being configured to rotate the platform;
the at least one solar panel being attached to the platform;
the at least one solar panel configured to generate electricity from photons;
the at least one reflector having a reflective component; and
the at least one reflector being oriented to direct light toward the at least one solar panel.

9. The solar tracking system of claim 8, further comprising:
the platform comprising at least one panel support;
the at least one solar panel comprising a window film and an actuator;
the window film being configured to filter infrared light;
the at least one solar panel being attached to the platform by connection between the panel support and the actuator; and
the at least one motor being configured to adjust the angle of the at least one solar panel relative to the platform by way of the actuator.

10. The solar tracking system of claim 8, further comprising:
a sensor device;
the sensor device being attached to the platform;
the system housing comprising a processor;
the at least one motor being configured to adjust the angle of the at least one solar panel relative to the platform;
the processor communicatively connected to the sensor device and the at least one motor; and
the processor being configured to activate the at least one motor based on information gathered by the sensor device.

11. The solar tracking system of claim 9, further comprising:
the at least one motor comprising a platform motor and an actuator motor;
the platform motor being configured to rotate the platform; and
the actuator motor being configured to adjust the angle of the at least one solar panel relative to the platform.

12. The solar tracking system of claim 8, further comprising:
the platform comprising a plurality of wheels and a plurality of dampers;
the plurality of wheels oppositely positioned on the platform from the at least one solar panel;
the plurality of dampers extending from the platform; and
the plurality of dampers configured to prevent rotation of the platform beyond a predetermined rotation.

13. The solar tracking system of claim 8, further comprising:
the platform further comprising a central bearing and a plurality of cable guides;
the central bearing centrally located on the platform;
the platform being configured to rotate around the central bearing;
the plurality of cable guides positioned along the structure edge; and
the cable being arranged among the plurality of cable guides.

14. The solar tracking system of claim 10, further comprising:
the sensor device further comprising a light sensor and a temperature sensor;
the light sensor configured to gather information about the direction and intensity of light; and
the temperature sensor configured to gather information about the temperature at the sensor device.

15. A solar tracking system, comprising:
a platform;
a system housing;
at least one motor;
at least one solar panel;
the platform comprising at least one panel support;
the at least one solar panel comprising a window film and an actuator;
the window film being configured to filter infrared light;
the at least one solar panel being attached to the platform by connection between the panel support and the actuator;
the at least one solar panel configured to generate electricity from photons;
the at least one motor being configured to rotate the platform; and
the at least one motor being configured to adjust the angle of the at least one solar panel relative to the platform by way of the actuator.

16. The solar tracking system of claim 15, further comprising:
a sensor device;
at least one reflector;
a cable;
the sensor device being attached to the platform;
the system housing comprising a processor;
the processor communicatively connected to the sensor device and the at least one motor;
the processor being configured to activate the at least one motor based on information gathered by the sensor device;
the platform further comprising a rounded structure and a structure edge;
the at least one motor connected to the structure edge by the cable;
the at least one reflector having a reflective component; and
the at least one reflector being oriented to direct light toward the at least one solar panel.

17. The solar tracking system of claim 15, further comprising:
the at least one motor comprising a platform motor and an actuator motor;
the platform motor being configured to rotate the platform; and
the actuator motor being configured to adjust the angle of the at least one solar panel relative to the platform.

18. The solar tracking system of claim 15, further comprising:
the platform comprising a plurality of wheels and a plurality of dampers;
the plurality of wheels oppositely positioned on the platform from the at least one solar panel;
the plurality of dampers extending from the platform; and
the plurality of dampers configured to prevent rotation of the platform beyond a predetermined rotation.

19. The solar tracking system of claim 16, further comprising:
the platform further comprising a central bearing and a plurality of cable guides;
the central bearing centrally located on the platform;
the platform being configured to rotate around the central bearing;
the plurality of cable guides positioned along the structure edge; and
the cable being arranged among the plurality of cable guides.

20. The solar tracking system of claim 16, further comprising:
the sensor device further comprising a light sensor and a temperature sensor;
the light sensor configured to gather information about the direction and intensity of light; and
the temperature sensor configured to gather information about the temperature at the sensor device.
